(19) United States
(12) Patent Application Publication
(10) Pub. No.: US 2009/0264317 A1
(43) Pub. Date: Oct. 22, 2009

(54) Functionalized nanostructure, methods of manufacture thereof and articles comprising the same

(75) Inventors: Yuval Ofir, Amherst, MA (US); Vincent Martin Rotello, Amherst, MA (US); Brian John Jordan, Andover, MA (US); Kenneth Raymond Carter, Hadley, MA (US)

Correspondence Address: CANTOR COLBURN, LLP, 20 Church Street, 22nd Floor, Hartford, CT, 06103, US

(73) Assignee: UNIVERSITY OF MASSACHUSETTS, Boston, MA (US)

(21) Appl. No.: 12/421,259

(22) Filed: Apr. 9, 2009

Related U.S. Application Data
(60) Provisional application No. 61/046,122, filed on Apr. 18, 2008.

(51) Int. Cl. C40B 50/14; C40B 30/00; C40B 40/04; C40B 40/06; C40B 40/10; B29C 35/08; B32B 3/00

(52) U.S. Cl. 506/16; 506/30; 506/7; 506/15; 506/18; 264/132; 264/496; 428/195.1; 422/68.1

(57) ABSTRACT

Disclosed is a method comprising disposing a functionalized patternable material on a substrate, wherein the functionalized patternable material comprises a first click chemical moiety; patterning the functionalized patternable material; and reacting the first click chemical moiety with a complementary reactant to form an functionalized patterned surface, the complementary reactant comprising a second click chemical moiety that reacts with the first click chemical moiety; the complementary reactant comprising an functional group.

### CROSS-REFERENCE TO RELATED APPLICATIONS

This application claims priority to provisional application 61/046,122 filed on Apr. 18, 2008, the entire contents of which are hereby incorporated by reference.

### FEDERAL RESEARCH STATEMENT

This invention was made with Government support from the National Science Foundation under Contract No. DMI-0531171. The Government has certain rights in the invention.

### BACKGROUND

This disclosure relates to functionalized nanostructures, methods of manufacture thereof, and articles comprising the same.

Patterned substrates having nanostructures with engineered spatial geometries are often produced by methods that involve depositing a layer or layers of a desired material on the substrate followed by the selective removal of certain portions of the deposited layer or layers. Examples of techniques that permit the depositing of layers of desired materials are spin coating, dip coating, chemical vapor deposition, plasma enhanced chemical vapor deposition, and the like. Examples of techniques that permit the selective removal of certain portions of the deposited layers are photolithography, solution etching, electron beam, ion beam, laser beam techniques, and the like. These selective removal techniques have several drawbacks. For example, solution etching such substrates exposes the deposited material to potentially harsh etching solutions, and can therefore degrade the desirable material properties of the substrate and limits applicable materials to those able to sustain the etching conditions. In addition, the use of etching to form a nanostructure can require multiple processing steps making it both complex and costly. In addition, patterning techniques involving electron beam, ion-beam or laser beam techniques are slow and are often performed in serial steps that are inherently costly for the replication of nanostructures. In addition, applications that use focused beams to pattern thin films can encounter unwanted redeposition of removed material, pyrolysis, or degradation resulting in unwanted contamination.

Patterned substrates can also be formed by processes such as ink-jet printing and screen printing. These processes are advantageous in that they do not utilize the selective removal techniques listed above. However, they do have several drawbacks. The resolution of ink-jet printing is limited by diffusion of the printed solution over the substrate and the rheological properties of the ink. In addition, it is limited by the size of the features that can be printed. Currently, printed structures of the order to a couple of micrometers are easily affordable. Screen printing also has limited resolution, thus has limited applicability to nanostructures.

Patterned substrates can also be produced by the use of self-assembled monolayers (SAMs). Micro-contact printing of SAMs can be used to provide self-assembled monolayers in spatially selected regions. However SAMs are two dimensional in nature, thus their micro-contact printing is limited to two dimensional structures. In addition, the chemistry of attachment of SAMs to surfaces is limited to thiolated molecules on gold or silane chemistry on oxide surfaces. Also, SAMs are limited by slow kinetics of assembly, poor uniformity and inconsistent reproducibility.

A need therefore exists for a low cost route for patterning nanostructures on substrates wherein selected portions of the nanostructures can be chemically functionalized and different portions of the nanostructures can have different chemical functionalization. It is also desirable to have a technique that can replicate nanostructures with selective chemical functionalization.

### SUMMARY

Disclosed herein is a method comprising disposing a functionalized patternable material on a substrate, wherein the functionalized patternable material comprises a first click chemical moiety; patterning the functionalized patternable material; and reacting the first click chemical moiety with a complementary reactant to form a functionalized patterned surface, the complementary reactant comprising a second click chemical moiety that reacts with the first click chemical moiety; the complementary reactant comprising a functional group.

Disclosed herein too is an article comprising a substrate; a functionalized patterned material disposed upon the substrate; the functionalized patterned material comprising a first click chemical moiety; the first click chemical moiety being reacted with a complementary reactant to form a functionalized patterned surface; the complementary reactant comprising a second click chemical moiety that reacts with the first click chemical moiety; the complementary reactant comprising a functional group.

Disclosed herein too is an article comprising a patterned material comprising a functionalized patterned surface and a surface that is opposedly disposed to the functionalized patterned surface; the functionalized patterned surface comprising a first click chemical moiety; the first click chemical moiety being reacted with a second click chemical moiety; the second click chemical moiety being part of a complementary reactant.

These and other features, aspects, and advantages of the disclosed embodiments will become better understood with reference to the following description and appended claims.

### BRIEF DESCRIPTION OF THE DRAWINGS

The disclosed subject matter is particularly pointed out and distinctly claimed in the claims at the conclusion of the specification. The foregoing and other objects, features, and advantages of the disclosed embodiments are apparent from the following detailed description taken in conjunction with the accompanying drawings in which:

FIG. 1 is a schematic diagram of a nanoimprinting in a chemically functionalized resist and the functionalization process of the resist using click chemistry type reactions;

FIG. 2 is a schematic diagram of a method for the manufacture of a functionalized microfluidic channels;

FIG. 3. is a schematic diagram of a method for the manufacture of a functionalized array; and

FIG. 4(A) is an image of azide functionalized polystyrene patterned using thermal nanoimprint lithography; and

FIG. 4(B) is an image illustrating the functionalization of specific regions of the azide functionalized polystyrene with FITC dye.

The detailed description explains the preferred embodiments together with its advantages and features, by way of example and with reference to the drawings.

### DETAILED DESCRIPTION

The singular forms “a,” “an,” and “the” include plural referents unless the context clearly dictates otherwise. Unless defined otherwise, technical and scientific terms used herein have the same meaning as is commonly understood by one of skill in the art to which this invention belongs. As used herein the terms “first,” “second” and the like do not denote any order or importance, but rather are used to distinguish one element from another. As used herein, approximating language can be applied to modify any quantitative representation that can vary without resulting in a change in the basic function to which it is related. Accordingly, a value modified by a term or terms, such as “about” and “substantially,” cannot to be limited to the precise value specified, in some cases. In at least some instances, the approximating language can correspond to the precision of an instrument for measuring the value. Thus the modifier “about” used in connection with a quantity is inclusive of the stated value and has the meaning dictated by the context (e.g., includes the degree of error associated with measurement of the particular quantity).

The terms “front”, “back”, “bottom”, and/or “top” are used herein, unless otherwise noted, merely for convenience of description, and are not limited to any one position or spatial orientation. The endpoints of all ranges directed to the same component or property are inclusive and independently combinable (e.g., ranges of “less than or equal to about 25 wt %, or, more specifically, about 5 wt % to about 20 wt %,” is inclusive of the endpoints and all intermediate values of the ranges of “about 5 wt % to about 25 wt %,” etc.). The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Disclosed herein is a method of disposing patterns on a substrate wherein selected portions of the patterns can be chemically functionalized and wherein different portions of the patterns can have different chemical functionalization. The chemical functionality of different parts of the patterns can be the same or different. The method involves disposing a patternable material that comprises a first click chemical moiety on a substrate. The patternable material is then patterned by a variety of methods.

Following the patterning, the first click chemical moiety is reacted with a complementary reactant that comprises a second click chemical moiety to produce a functionalized patterned surface. The first and second click chemical moieties can selectively form a covalent bond. In one embodiment, after the patterning, the substrate can be removed to yield a patterned material. The patterned material, which comprises the first click chemical moiety, can then be reacted with the complementary reactant that comprises the second click chemical moiety to produce a functionalized patterned surface.

A patternable material is one that can be shaped or reshaped by the use of pressure, by the use of techniques that involve etching, or the like. It is generally desirable for the patternable material to retain its shape at temperatures of about 0° C. to about 300° C.

In one embodiment, the complementary reactant can further comprise an active functional group and thus the bonding of the complementary reactant to the patternable material has the effect of bonding the active functional group to the patternable material. An active functional group is one that can further react or interact with other atoms and/or molecules. In another embodiment, the complementary reactant comprises a functional group that is passive, i.e., it does not participate in a reaction or an interaction with another atom and/or molecule.

The method disclosed herein can be used to produce 3-dimensional patterns where different portions of the patterns have different functionalities. For example, the vertical surfaces of a pattern can have a first functional group, while the horizontal surfaces of the pattern can have a second functional group. The use of multiple “click” functional groups thus provides a method for the manufacture of multi-functional structures on 3-dimensional surfaces. In addition, selected surfaces of the pattern can be functionalized with one or more functional groups that have selected properties or capabilities. These functionalized patterned surfaces can be used in a variety of applications such as microfluidics, molecular analysis, electronic devices and the like. The method can also be used to add functionalized patterned surfaces to pre-existing 3-dimensional architectures if desired.

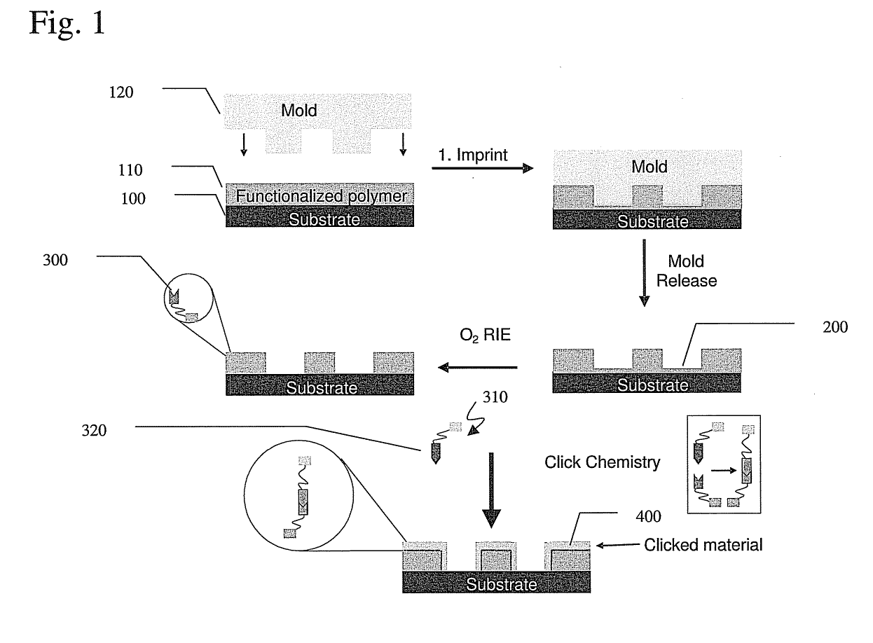

FIG. 1 depicts a functionalized patternable material 110 disposed on substrate 100. The functionalized patternable material comprises a first click chemical moiety 300. The functionalized patternable material 100 can be patterned using a variety of different processes. While in the FIG. 1, the functionalized patternable material is patterned using mold 120, other methods of patterning can also be used. Patterning is generally conducted by using nanoimprint lithography. This will be detailed below. The mold 120 is heated to a temperature greater than the flow temperature of the functionalized patternable material 110 and then brought into contact with the material 110 to imprint a pattern of the mold into the functionalized polymeric material 110. The mold is then removed. Residual portions 200 of the functionalized patternable material can be removed by an etching process if desired. The first click chemical moiety 300 is then reacted with a complementary reactant 310 that comprises a second click chemical moiety 320 and a functional group to provide the functionalized patterned surface 400.

As noted above, a functionalized patternable material 110 having a first click chemical moiety 300 is first disposed upon a substrate 100. The substrate can be electrically insulating, electrically conducting or semi-conducting if desired. An electrically conducting substrate is one that has an electrical conductivity of 10¹² ohm-cm or lower, while an electrically insulating substrate has an electrical resistivity of 10¹² ohm-cm or higher. In one embodiment, the substrate can be opaque to electromagnetic radiation, while in other embodiments, the substrate can be transparent to electromagnetic radiation. In an exemplary embodiment, the substrate is transparent to ultraviolet radiation.

Suitable substrates 100 can comprise organic polymers, ceramics, metals, or combination comprising at least one of the foregoing substrates. Exemplary substrates comprise silicon, glass, indium tin oxide, antimony tin oxide, quartz, metal alloys, metal oxides, semiconductors, semiconductor alloys, an organic solid, or the like, or a combination comprising at least one of the foregoing substrate materials.

The functionalized patternable material 110 can be either an organic material or an inorganic material. Carbon nanotubes, proteins, peptides, or the like, can also be used as the functionalized patternable material 110. Suitable examples of organic materials are organic polymers, polymer precursors, thermoplastic polymers, blend of thermoplastic polymers, thermosetting polymers, or blends of thermoplastic polymers with thermosetting polymers. The functionalized patternable material 110 can comprise a blend of polymers, copolymers, terpolymers, or combinations comprising at least one of the foregoing polymeric materials. The patternable material can also be an oligomer, a homopolymer, a copolymer, a block copolymer, an alternating block copolymer, a random polymer, a random copolymer, a random block copolymer, a graft copolymer, a star block copolymer, a dendrimer, or the like, or a combination comprising at least one of the foregoing patternable materials.

Examples of the thermoplastic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, fluorinated polymers, or the like, or a combination comprising at least one of the foregoing thermoplastic polymers.

Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like.

Polymer precursors that can be used in the functionalized patternable material 110 are those that can be cured by electromagnetic radiation such as ultraviolet light, microwave energy and electron beam radiation. It is generally desirable to use polymer precursors that can be cured using ultraviolet light. Polymer precursors are generally defined as reactive species that have less than about 25 repeat units. Examples of suitable polymer precursors are monomers, dimers, trimers, pentamers, and the like. Cyclic molecules having less than 25 repeat units may also be used as the patternable material. The polymer precursors having the appropriate functional groups are generally reacted or cured using electromagnetic radiation after being subjected to nanoimprint lithography. In general, the polymer precursors form a thermosetting polymer after the curing process is completed.

Examples of thermosetting polymers that may be produced by irradiating polymer precursors include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylic polymers, acrylate polymers, methacrylate polymers, polyalkyds, phenol-formaldehyde polymers, novolac polymers, resole polymers, melamine-formaldehyde polymers, urea-formaldehyde polymers, polyhydroxymethylfurans, polyisocyanates, diallyl phthalate polymers, triallyl cyanurate polymers, triallyl isocyanurate polymers, unsaturated polyesterimides, or the like, or a combination comprising at least one of the foregoing thermosetting polymers.

Suitable examples of inorganic materials are inorganic polymers, inorganic polymer precursors, or the like, or a combination comprising at least one of the foregoing inorganic materials. Examples of suitable inorganic polymers are polyphosphazenes, polysilanes, polysilazanes, polyferrocenylsilanes, polystannanes, porphyrin polymers, oligodioxaboroles, polycarboranes, or the like, or a combination comprising at least one of the foregoing inorganic polymers.

In one embodiment, the substrate can be removed after the patterning to produce a patterned material. In this embodiment, the substrate is separated from the patterned material. The patterned material may then be reacted with the complementary reactant to produce the functionalized patterned material that comprises a functionalized patterned surface. The patterned material can then be optionally reacted with additional complementary reactants (that may or may not involve click chemistry) to functionalize the surface that is opposedly disposed to the functionalized patterned surface. In one embodiment, the surface that is opposedly disposed to the functionalized patterned surface may itself be subjected to optional patterning prior to optionally reacting it with a complementary reactant.

The substrate can be removed by mechanical, chemical and/or particle bombardment processes. Mechanical processes involve abrasion, peeling, or the like, or a combination comprising at least one of the foregoing mechanical processes. Chemical processes involve dissolution, etching, or the like, or a combination comprising at least one of the foregoing mechanical processes. Particle bombardment processes involve ion beam etching, reactive ion beam etching, ion beam milling, or the like, or a combination comprising at least one of the foregoing particle bombardment processes.

After the removal of the substrate, the patterned material may be subjected to reaction with the complementary reactant to effect a reaction between the first click chemical moiety and the second click chemical moiety. It is to be noted that the patterned material may be subjected to additional forming processes after removal from the substrate. In addition, the patterned material may be reacted with different complementary reactants on its opposing surfaces. For example a first complementary reactant can be reacted with the patterned surface, while a second complementary reactant can be reacted with the surface that has just been disconnected from the substrate. Each complementary reactant can have different click chemical moieties, if desired.

As noted, the first click chemical moiety is selectively coupled to the functionalized patternable material. Thus upon patterning the functionalized patternable surface, the surface comprises a 3-dimensional pattern that comprises a functionalized surface. In one embodiment, the bond between the first click chemical moiety and the patternable material should be stable under aqueous reaction conditions to minimize cost and increase the durability of a functionalized surface. In addition, the bonding of the first click chemical moiety to the patternable material should be robust so that it can sustain subsequent processing, including exposure to water or organic solvents, without loss of the first click chemical moiety. Exemplary methods to bond the first click chemical moiety to the patternable material are those that form a covalent bond, including methods that utilize click chemical reactions. The reaction between the first click chemical moiety and the patternable material to produce the functionalized patternable material 110 should also be highly selective and provide high yield to avoid bonding of unwanted species to the patternable material.

Recently, Sharpless et al. defined “click chemistry” as a set of highly reliable, high yielding and selective synthetic reactions useful for coupling molecules (Kolb, H. C., Finn, M. G., and Sharpless, K. B. Angew. Chem. Int. Ed. 2001, 40, p. 2005). The click synthetic framework offers chemical versatility because the reactions are largely modular, stereospecific, proceed in high yields, and are tolerant to a variety of solvents including water, functional groups, and air. The robustness and diversity of click chemistry reactions make click chemistry a very useful system for modifying surface properties. Click chemistry has been described by Moses et al., the contents of which are hereby incorporated by reference in its entirety. (J. E. Moses and A. D. Moorhouse, Chem. Soc. Rev 2007, 1249-1262).

Examples of the first click chemical moieties can be an alkynyl groups, azido groups, nitrile groups, conjugated diene groups, epoxide groups, carbonyl groups, aziridine groups, or the like, or a combination comprising at least one of the foregoing groups, so long as the first click chemical moiety can participate in a selective covalent bond forming reaction with a second click chemical moiety.

Table 1 below provides a non-exhaustive list of first and second click chemical moieties that can be used in the functionalized patterned surface. It is to be noted that either the first or the second click chemical moiety can be used in the patternable material, while the complementary reactant can use the corresponding click chemical moiety. Table 1 also depicts the chemistry that can be employed to react the first click chemical moiety with the second click chemical moiety.

TABLE 1

| | First click | Second click |
|---|---|---|
| Reaction Name | chemical moiety | chemical moiety |
| 1,3-Huisgen Dipolar Cycloaddition | 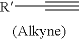 | R″—N₃ (Azide) |
| 1,3-Huisgen Dipolar Cycloaddition | R′—C≡N (Nitrile) | R″—N₃ (Azide) |
| 1,3-Huisgen Dipolar Cycloaddition | R′—N₃ (Azide) | 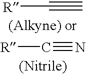 |
| Diels-Alder Cycloaddition | 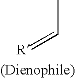 | 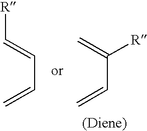 |
| Diels-Alder Cycloaddition | 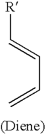 | 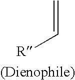 |
| Diels-Alder Cycloaddition | 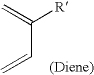 | 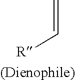 |
| Non-Aldol Carbonyl Chemistry | R′—N═C═O (Isocyanate) | R″—NH₂ (Amine) |
| Non-Aldol Carbonyl Chemistry | R′—N═C═S (Isothiocyanate) | R″—NH₂ (Amine) |
| Non-Aldol Carbonyl Chemistry | R′—NH₂ (Amine) | R″—N═C═S (Isothiocyanate) or R″—N═C═O (Isocyanate) |
| Non-Aldol Carbonyl Chemistry | 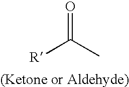 | 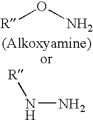 |
| Michael addition | 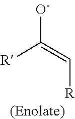 | 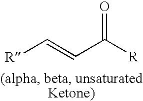 |
| Nucleophilic Ring Opening Reactions | 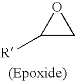 | Nuc-R″ |

Key
R′ = patternable material
R″ = any material to be deposited onto the functionalized patterned surface via “click” chemistry
R = any chemistry (last two examples in the table)
Nuc = nucleophilic molecules

As can be seen in Table 1, the first click chemical moiety and the second click chemical moiety can react with each other through a 1,3-Huisgen dipolar cycloaddition reaction, a Diels-Alder cycloaddition reaction, a Michael addition reaction, a nucleophilic ring opening reaction, a C═C addition reaction, or a non-Aldol carbonyl reaction.

In one exemplary embodiment, a reaction between a first click chemical moiety and a second click chemical moiety involves the reaction of azides with either alkynyl groups or alkyne groups or both alkynyl groups and alkyne groups to form a triazole. This reaction is chemoselective, only occurring between alkynyl and azide functional groups and occurs with high yield. In addition, the resulting 1,2,3-triazoles are stable in aqueous conditions and at elevated temperature.

In one embodiment, in one method of manufacturing the functionalized patterned surface, the functionalized patternable material 110 is first disposed upon the substrate. The functionalized patternable material 110 can be disposed on the substrate by spin coating, dip coating, spray coating, layer by layer assembly, drop casting, electrostatic painting, or the like, or a combination comprising at least one of the foregoing coating methods.

Following the disposing of the functionalized patternable material 110 on the substrate 100, it is subjected to patterning to create the patterned surface. In one embodiment, patterning is accomplished via nanoimprint lithography. Nanoimprint lithography is a method that can replicate nanoscale patterns with high throughput and at low cost, thus it is a commercially attractive method for the replication of nanopatterns. Nanoimprint lithography involves the molding of nanoscale patterns from a mold to the functionalized patternable material that is disposed on a substrate.

Available methods of nanoimprint lithography include thermoplastic nanoimprint lithography (T-NIL), photo-nanoimprint lithography (P-NIL), and a variant termed step-and-flash imprint lithography (S-FIL). These methods utilize passive molds.

In thermoplastic nanoimprint lithography, a mold is heated to a temperature above the flow temperature of the functionalized patternable material and is then disposed on the functionalized patternable material while pressure is applied to the mold. The imprinting pressure and temperature are maintained for a period of time to allow the functionalized patternable material to flow and conform to the geometry of the mold. After cooling the system to a temperature below the flow temperature of the functionalized patternable material, the mold is removed from the functionalized patternable material to leave the molded features in the functionalized patternable material.

During the molding of the functionalized patternable material in the thermoplastic nanoimprint lithography, the temperature of the functionalized patternable material is raised to a temperature of about 15 to about 50° C. above the flow temperature of the patternable material. The pressure applied to the mold can be about 100 to about 20,000 kilopascals (kPa), about 1500 to about 15,000 kPa, or about 5000 to about 10,000 kPa. The pressure and temperature can be maintained for about 1 to about 1000 minutes, about 3 to about 500 minutes, or about 5 to about 50 minutes to allow the functionalized patternable material to flow and conform to the geometry of the mold. The temperature of the functionalized patternable material is then lowered to below its flow temperature. Alternatively, the temperature of the mold, substrate and patternable material can be lowered to below the flow temperature of the patternable material. The mold can then be removed leaving the imprinted features in the patternable material.

In another embodiment, photo-nanoimprint lithography may be used to pattern the functionalized patternable material. In this embodiment, the functionalized patternable material is a polymer precursor (e.g., a ultraviolet curable resin) capable of being polymerized upon exposure to ultraviolet irradiation. Ultraviolet light, for example 365 nm light from a mercury source, can be utilized to initiate curing or polymerization of the functionalized patternable material. Removal of the mold after the curing or polymerization of the functionalized patternable material results in a patterned surface comprising the molded features.

In one embodiment, in photo-nanoimprint lithography, a functionalized patternable polymer precursor is first disposed on the substrate, following which a mold is disposed on the ultraviolet curable resin to pattern the surface. The mold is generally transparent to ultraviolet radiation. Pressure applied to the surface via the mold causes the surface to be patterned. After the surface is patterned, the polymer precursor is irradiated with ultraviolet light, optionally through the transparent mold, to initiate curing. The mold can then be removed leaving behind the patterned surface.

In another embodiment, in another method of using photo-nanoimprint lithography, the substrate (upon which the functionalized patternable material is disposed) is transparent to ultraviolet light. Ultraviolet radiation can thus be transmitted through the substrate to cure the functionalized patternable material while pressure is simultaneously applied to the functionalized patternable material via the mold. Upon achieving the desired degree of curing, the mold can be removed. In another embodiment, the ultraviolet light can be used to cure the functionalized patternable material by simultaneously transmitting light through the ultraviolet transparent substrate and the ultraviolet transparent mold. Once again, upon achieving the desired degree of curing, the mold is removed. In addition to ultraviolet radiation, other forms of radiation such as microwave radiation, infrared radiation, xrays and electron beam radiation may also be used to effect the curing of the patternable material. Other methods of lithography such as scanning probe lithography, interference lithography, proton beam lithography, or laser ablation lithography can also be used to from the functionalized patterned surface.

In one embodiment, combinations of the aforementioned types of radiation can be used simultaneously or sequentially to effect curing of the functionalized patternable material. In another embodiment, the aforementioned forms of radiation can also be used in conjunction with heat supplied to either the substrate or the mold through conduction, convection or a combination of conduction and convection.

In one embodiment, the functionalized patterned surface can have 2 or 3-dimensional structural features. The functionalized patterned surface can comprise a variety or regular or irregular geometrical features as a result of the patterning. Regular geometrical features are those that follow Euclidean geometry, in which, the mass of the feature is directly proportional to a characteristic dimension of the feature raised to an integer number. Examples of regular geometrical features are triangles, squares, spheres, hemispheres, rods, polygons, buckeyeballs, or the like, or a combination comprising at least one of the foregoing geometries. Irregular geometrical features are those that follow non-Euclidean geometry, in which, the mass of the feature is directly proportional to a characteristic dimension of the feature raised to a fractional number. Examples of non-Euclidean geometries are fractals. Fractals can be surface or mass fractals. The patterned features can have dimensions in the micrometer range or in the nanometer range. As defined herein when a pattern is characterized as having dimensions in the nanometer range, then at least one dimension of the pattern is less than or equal to about 100 nanometers.

The functionalized patternable material upon being patterned can then be post-processed. Post-processing can include a variety of steps including additional molding, additional curing using thermal energy or electromagnetic radiation, etching, or the like, or a combination comprising at least one of the foregoing post processing methods. Etching can include reactive ion etching, chemical etching, or the like, to remove undesirable portions of the functionalized patternable material or to expose the underlying substrate.

The first click chemical moiety in the functionalized patternable material can then be reacted with a complementary reactant, the complementary reactant comprising a second click chemical moiety, to provide a functionalized surface. As noted above, click reactions are selective. Thus where the first click chemical moiety is an alkynyl group, the second click reactant can comprise an azide group or vice versa. Table 1 above provides the first click chemical moiety and the second click chemical moiety that is to be contained in the complementary reactant in order to facilitate the click chemistry.

As note above, the complementary reactant can further comprise an active functional group or a passive functional group or both an active functional group and a passive functional group. The active functional group can be used to facilitate additional reactions with desired species in a given situation, can be used for selectively interacting with desired species in a microfluidic or analytical device, or the like. The active or passive functional group can be, a protein, a nucleic acid such as deoxyribonucleic acid, ribonucleic acid, an antibody, an antigen, a peptide, a metabolite, a receptor, a drug, an enzyme, a nanoparticle, a nanocrystal, a nanotube, a nanowire, a biomolecule, a catalyst, a chiral molecule, a dye, a chromophore, a fluorophore, a small molecule, a polymer, or the like, or a combination comprising at least one of the foregoing active functional groups. In an exemplary embodiment, the active functional group is flavin dye or the fluorochrome fluorescein isothiocyanate (FITC). A small molecule as defined herein is a molecule having up to about 30 repeats units. It is to be noted that the term “nanotubes” can encompass all types of nanotubes and not just carbon nanotubes.

Examples of chemical species (active or passive) in the functional groups are SO₃H, COOH, NH₂, OH, R′CHOH, CHO, CN, COCl, COSH, SH, COOR′, SR′, SiR₃′, Si—(OR′)_{y}—R′_{(3-y)}, AlR₂′, halide, thiophene, ethylenically unsaturated functionalities, epoxide functionalities, or the like, wherein R′ is hydrogen, alkyl, aryl, cycloalkyl, or aralkyl, cycloaryl, poly(alkylether), or the like.

Thus, using the above disclosed method, an article comprising a substrate and having a functionalized patterned surface can be manufactured wherein selected surfaces of the article are functionalized with an active functional group having selected properties or reactive capabilities. In other words, an article with three-dimensional structural features can be manufactured, wherein selected surfaces of the structural features are functionalized with one or more functional groups that have selected properties or capabilities.

In an exemplary embodiment, in one manner of proceeding, thermoplastic nanoimprint lithography is used to pattern an azide functionalized polystyrene film. The azide-functionalized polystyrene can be synthesized from chloromethylstyrene copolymer and sodium azide. A solution of the azide-functionalized polystyrene in a solvent is spin coated onto a silicon wafer (that acts as the substrate) to form a thin film. Exemplary solvents include organic solvents, chloroform, a water-alcohol mixture in a 1:1 weight ratio, or the like, or a combination comprising at least one of the foregoing solvents. Thermoplastic nanoimprint lithography can then be used to imprint a pattern into the film of the azide-functionalized polystyrene using a silicon mold. The patterned azide-functionalized polystyrene can then be etched to remove residual azide-functionalized polystyrene. The remaining azide-functionalized polystyrene can then be reacted with a complementary reactant that comprises an alkynyl group and a dye functionality to form a surface that is selectively functionalized with the dye.

The disclosed method is advantageous over other methods because it permits a functionalized patternable material to be disposed on any suitable substrate using versatile and robust methods such as spin coating. When thermoplastic nanoimprint lithography is used, as discussed above, the functionalized patternable material is directly patterned before the active functional group is coupled to the surface via a click reaction, thereby improving the versatility and robustness of the method. On the other hand, when photo nano-imprint lithography is used, the functionalized patternable material can be either first cured and then patterned or alternatively first patterned and then cured. The disclosed method can provide 3-dimensional surfaces, although it is also applicable to the manufacture of two-dimensional and flat surfaces. The use of multiple “click” functional groups provides a method for the manufacture of multi-functional structures on 3-dimensional surfaces. In addition, selected surfaces of the patterned surfaces can be functionalized with one or more functional groups that have selected properties or capabilities.

The disclosed method allows for rapid and facile replication of three-dimensional patterns wherein selected features of a pattern can be selectively chemically functionalized. Because the complementary reactant is covalently bonded to the functionalized organic polymer to form the functionalized surface, the functionalized surface can be washed to remove non-specific absorbing species without loss of chemical functionality. In addition, the reaction of the first click chemical moiety of the functionalized organic polymer and the second click chemical moiety of the complementary reactant enables chemical versatility because of the variety of click reactions available and their selectivity. This chemical versatility enables fabrication of articles for combinatorial applications, such as nucleic acid or drug discovery arrays, multifunctional surfaces or microfluidic devices.

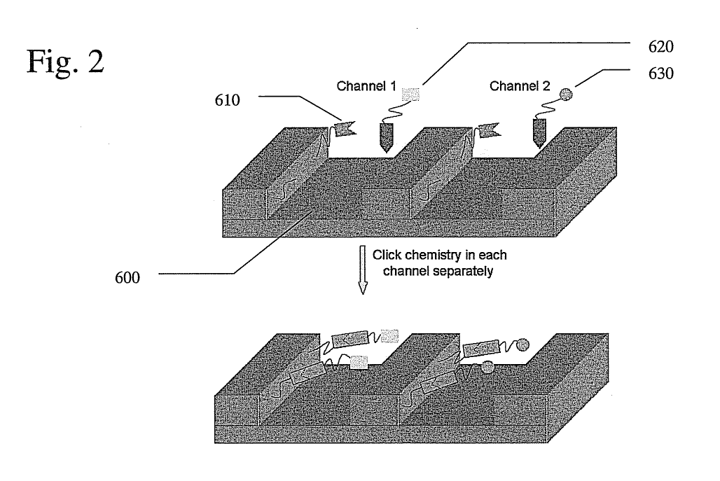

The aforementioned method can be advantageously used to manufacture a wide variety of functionalized patterned surfaces. As noted above, it has been observed that different features of a pattern can be chemically functionalized with different functional groups using the disclosed method. In one embodiment, as depicted in the FIG. 2, the method can be used to manufacture a microfluidic device. Using nanoimprint lithography, as described above, a pattern comprising a plurality of channels 600 can be imprinted in the functionalized patterned material. The functionalized patterned material can comprise a first click chemical moiety 610. Each channel can then be individually reacted with a different complementary reactant, for example a first complementary reactant 620 and a second complementary reactant 630. The complementary reactants can thus comprise different active functional groups. Thus a microfluidic device comprising multiple channels wherein different channels having different chemical functionalities can be fabricated.

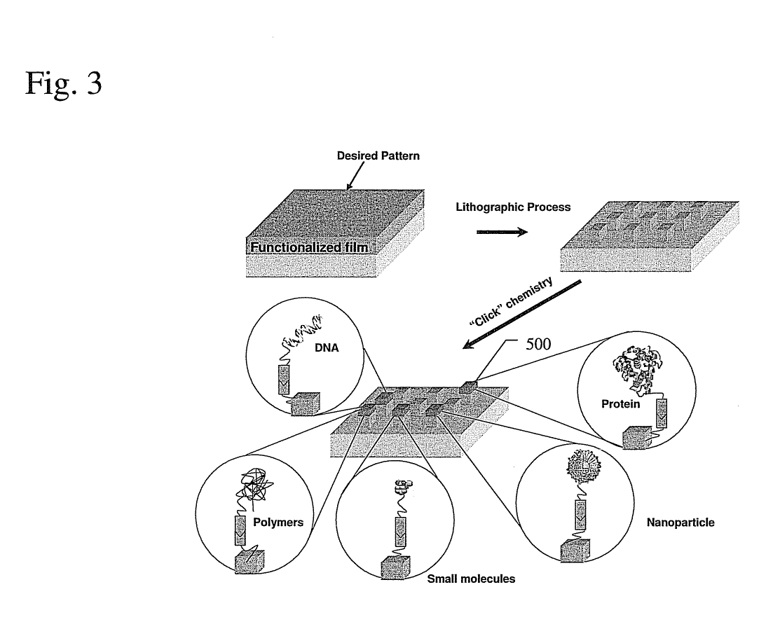

The FIG. 3 is another depiction of an array manufactured by using nanoimprint lithography. Using nanoimprint lithography, as described above, an array comprising a plurality of locations 500 can be fabricated from the functionalized patternable material. Each location in the array can be individually reacted with a different complementary reactant. The complementary reactants can comprise different active functional groups. Thus an array comprising locations with distinct chemical functionality can be fabricated.

The aforementioned method can be used to produce articles with a variety of patterned surfaces that have different functional groups. In one embodiment, a patterned surface having a gradient in functional groups can be produced, wherein the density of a particular active functional group can be systematically varied across the pattern. Thus a pattern, such as, for example, a microfluidic channel, can have a first density of active functional groups at a proximate end while the density of the active functional groups can vary along the length of the pattern, the pattern having a second density of the active functional groups at a distal end. In one embodiment, the article can comprise an array for the analysis of an organic, inorganic or biological analytes. The aforementioned method for producing functionalized patterned surfaces can also be actively employed in the manufacture of articles such as microfluidic devices, circuit boards, analytical devices, sensors, a genome sequencing array, a DNA sensing array, a drug discovery array, a protein sensing array, a peptide array, a non-fouling surface, a low friction surface, an optically active surface, or a lab-on-a-chip sensor, or the like.

The invention is further illustrated by the following non-limiting examples.

### EXAMPLES

### Example 1

This example was conducted to demonstrate the manufacturing of a functionalized patterned surface using an azide functionalized chloromethylstyrene copolymer. The functionalized surface was prepared using the materials described in Table 2.

TABLE 2

| Material | CAS #* | Grade | Supplier | Description |
|---|---|---|---|---|
| Chloromethylstyrene | | | Synthesized in lab | See Org. |
| copolymer | | | | Lett. 2005, |
| | | | | Vol 7, No. 13, |
| | | | | pages |
| | | | | 2551-2554 |
| Dimethylsulfoxide (DMSO) | 67-68-5 | ACS | Sigma Aldrich | Solvent |
| Sodium azide (NaN₃) | 26628-22-8 | ACS | Fisher Scientific | White solid |
| | | | Company | |
| Silicon substrate | | | University Wafer | 8 inch wafer |
| Copper Sulfate (5H₂O) | 7758-99-8 | ACS | Fisher Scientific | Blue solid |
| | | | Company | |
| Sodium L-ascorbate | 134-03-2 | 99+% | Sigma Aldrich | White solid |
| Flavin | | | Synthesized in lab | See Org. |
| | | | | Lett. Paper |
| | | | | above |
| Fluorescein- | 27072-45-3 | ~90% | Sigma Aldrich | Orange |
| Isothiocyanate | | | | powder |
| 4-Ethynylaniline | 142-35-815 | 97% | Sigma Aldrich | Yellow |
| | | | | powder |
| Fluorescein-Alkyne | | | Synthesized in lab | Orange- |
| | | | | yellow |

*CAS # = chemical abstract number

### Preparation of Patternable Material Comprising Azide Functionalized Polystyrene

The preparation of a patternable material comprising azide-functionalized polystyrene is also described in the supporting information in Table 1 to J. B. Carroll et al. Org. Lett. 2005, Vol. 7, No. 13, 2551-2554, the contents of which is incorporated herein by reference in its entirety. To a solution of chloromethylstyrene copolymer (0.2 mmol) in DMSO (10 ml) was added an excess of NaN₃ (2 mmol, ˜10 eq. azide per polymer chain). The reaction was allowed to proceed overnight. The functionalized organic polymer was then precipitated from H₂O. The crude functionalized organic polymer was then filtered, washed with copious amounts of H₂O, and allowed to dry yielding the azide functionalized polystyrene (0.196 mmol, 98% yield).

A 5 percent solution by weight of the azide-functionalized polystyrene in chloroform was deposited by spin coating onto a silicon substrate to form a film of the azide functionalized organic polymer on the silicon substrate. The substrate was spun from 1000 to 3000 rpm over 1 minute using a Specialty Coating Systems, Inc. spin coating apparatus (model P 6204). Thermoplastic nanoimprint lithography was used to imprint features into the azide functionalized organic polymer film using a silicon mold. The mold comprised a series of channels. The largest feature had cross sectional dimensions of 50 micrometers by 50 micrometers. The smallest feature had cross sectional dimensions of 100 nanometers by 100 nanometers. The features were 100 micrometers long. Imprinting was performed at about 150° C. and about 2758 kilopascals (kPa) for about 2 minutes after which the system was allowed to cool to room temperature. A residual layer of azide functionalized polystyrene remaining in the bottom of the channels was removed by reactive ion etching under an oxygen plasma for about 20 seconds to expose the underlying substrate.

A fluorescein isothiocyanate (FITC) dye functionalized with an alkyne group to form the complementary reactant. An acetone solution of FITC was mixed with 4-ethynylaniline (1:1) and stirred over night at room temperature in dark. The solution was used “as is” after the reaction.

The azide-functionalized polystyrene was then reacted with the alkyne functionalized FITC dye by first immersing the imprinted azide functionalized polystyrene in 2 milliliters of a 1 millimolar water solution of the alkyne functionalized FITC dye. Next, 0.04 milliliters of a 4 millimolar solution of copper sulfate (CuSO₄.5H₂O) in water was added followed by addition of 0.3 milliliters of a 6 millimolar solution of sodium ascorbate in water. The solution turned brown in color upon standing. After about 24 hours, the functionalized nanostructure was removed and washed with 10 milliliters of water followed by 10 milliliters of ethanol at 25° C. for 10 minutes.

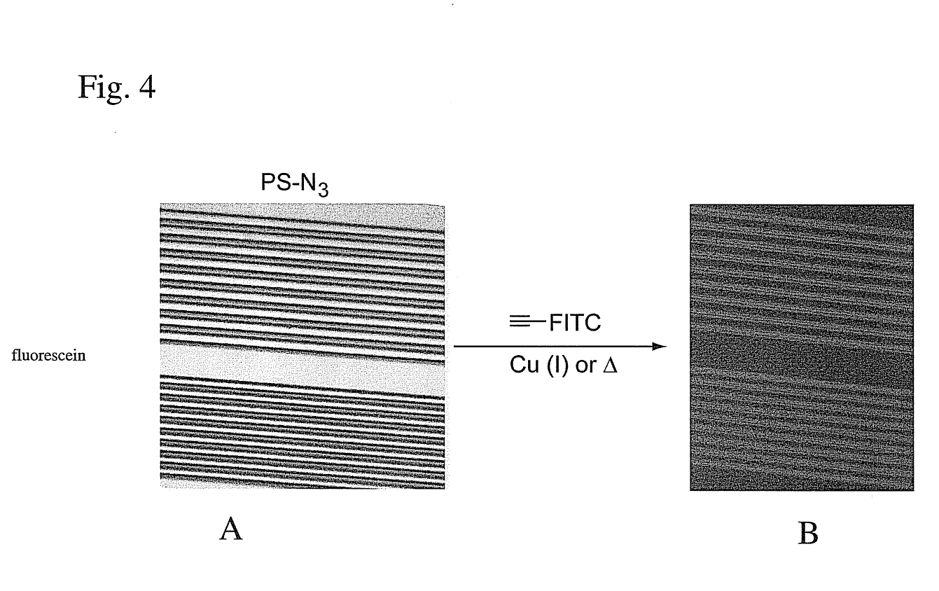

The textured surface was then analyzed through optical fluorescence microscopy (Olympus BX51) using either SWB (420-480 nm) or SWG (480-550 nm) exciting wavelengths. FIG. 4 is an image of the textured surface before (A) and after (B) reaction with the FITC dye. Image A illustrates the pattern imprinted into the reactive polymer. Image B illustrates the polystyrene has been functionalized with the FITC dye only in selected regions.

### Example 2

An azide functionalized organic polymer was prepared, imprinted and chemically functionalized as in Example 1, except that ethanol:water (2:1 by weight) mixture was used instead of water.

### Example 3

An azide functionalized organic polymer was prepared, imprinted and chemically functionalized as in Example 1, except that a 1 millimolar solution of flavin dye in ethanol:water (2:1 by weight) mixture was used instead of the FITC dye.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein. In addition, modifications can be made to adapt a particular situation or material to the teachings of this disclosure without departing from the essential scope thereof Therefore, it is intended that the invention not be limited to the particular embodiment disclosed as the best mode contemplated for carrying out the disclosed method.

What is claimed is:

1. A method comprising:
disposing a functionalized patternable material on a substrate, wherein the functionalized patternable material comprises a first click chemical moiety;
patterning the functionalized patternable material to form a patterned material; and
reacting the first click chemical moiety with a complementary reactant to form a functionalized patterned surface, the complementary reactant comprising a second click chemical moiety that reacts with the first click chemical moiety; the complementary reactant comprising a functional group.

2. The method of claim 1, wherein the functionalized patternable material is disposed by spin coating, dip coating, spray coating, layer by layer assembly, drop casting, electrostatic painting, or a combination comprising at least one of the foregoing methods of coating.

3. The method of claim 1, wherein the functionalized patternable material is a polymer precursor that can be cured using electromagnetic radiation.

4. The method of claim 1, wherein the functionalized patternable material comprises a polymer precursor, an organic polymer and/or an inorganic polymer.

5. The method of claim 1, wherein the patterning comprises nanoimprint lithography.

6. The method of claim 5, wherein the nanoimprint lithography comprises thermoplastic nanoimprint lithography, photo-nanoimprint lithography, or a combination comprising at least one of the foregoing methods of nanoimprint lithography.

7. The method of claim 6, wherein the thermoplastic nanoimprint lithography is performed at a temperature that is about 15 to about 50° C. greater than the flow temperature of the functionalized patternable material.

8. The method of claim 6, wherein the photo-nanoimprint lithography is conducted by using ultraviolet radiation.

9. The method of claim 6, wherein the patterning can be conducted with electron beam lithography, scanning probe lithography, interference lithography, x-ray lithography, proton beam lithography, laser ablation lithography, or a combination comprising at least one of the foregoing methods of lithography.

10. The method of claim 1, further comprising separating the substrate from the patterned material.

11. The method of claim 10, further comprising reacting a complementary reactant to a surface that is opposed to the functionalized patterned surface.

12. An article manufactured by the method of claim 1.

13. A method comprising:
disposing a functionalized patternable material on a substrate, wherein the functionalized patternable material comprises a first click chemical moiety;
patterning the functionalized patternable material to form a patterned material;
separating the substrate from the patterned material;
reacting the patterned material with a first click chemical moiety to form a first functionalized patterned material; and
reacting the functionalized patterned material with a complementary reactant to form a functionalized patterned surface, the complementary reactant comprising a second click chemical moiety that reacts with the first click chemical moiety; the complementary reactant comprising a functional group.

14. The method of claim 13, wherein the patterning comprises nanoimprint lithography, and wherein the nanoimprint lithography comprises thermoplastic nanoimprint lithography, photo-nanoimprint lithography, or a combination comprising at least one of the foregoing methods of nanoimprint lithography.

15. An article manufactured by the method of claim 13.

16. An article comprising:
a substrate;
a functionalized patterned material disposed upon the substrate; the functionalized patterned material comprising a first click chemical moiety; the first click chemical moiety being reacted with a complementary reactant to form a functionalized patterned surface; the complementary reactant comprising a second click chemical moiety that reacts with the first click chemical moiety; the complementary reactant comprising a functional group.

17. The article of claim 16, wherein the substrate is electrically conducting, electrically insulating or semi-conducting.

18. The article of claim 16, wherein the substrate comprises silicon, glass, quartz, metal alloys, metal oxides, indium tin oxide, antimony tin oxide, semiconductors, semiconductor alloys, an organic polymer, an inorganic polymer, or a combination comprising at least one of the foregoing substrate materials.

19. The article of claim 16, wherein the first click chemical moiety comprises an alkynyl group.

20. The article of claim 16, wherein the second click chemical moiety comprises an azido group

21. The article of claim 16, wherein the functionalized patternable material is a carbon nanotube, a polymer precursor, a thermoplastic polymer, a blend of thermoplastic polymers, a thermosetting polymer, or a blend of thermoplastic polymers with thermosetting polymers.

22. The article of claim 21, wherein the thermoplastic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, polysiloxane, a fluorinated polymer, or a combination comprising at least one of the foregoing thermoplastic polymers.

23. The article of claim 21, wherein the thermosetting polymer is an epoxy polymer, an unsaturated polyester polymer, a polyimide polymer, a bismaleimide polymer, a bismaleimide triazine polymer, a cyanate ester polymer, a vinyl polymer, a benzoxazine polymer, a benzocyclobutene polymer, an acrylic polymer, an acrylate polymer, a methacrylate polymer, a polyalkyd, a phenol-formaldehyde polymer, a novolac polymer, a resole polymer, a melamine-formaldehyde polymer, a urea-formaldehyde polymer, a polyhydroxymethylfuran, a polyisocyanate, a diallyl phthalate polymer, a triallyl cyanurate polymer, a triallyl isocyanurate polymer, an unsaturated polyesterimide, or a combination comprising at least one of the foregoing thermosetting polymers.

24. The article of claim 16, wherein the functional group is a reactive species, a protein, a nucleic acid, deoxyribonucleic acid, ribonucleic acid, an antibody, an antigen, a metabolite, a receptor, an enzyme, a nanoparticle, a nanocrystal, a nanowire, a nanotube, a biomolecule, a catalyst, a chiral molecule, a dye, a peptide, an oligonucleotide, a chromophore, a fluorophore, a small molecule, a polymer, or a combination comprising at least one of the foregoing functional groups.

25. The article of claim 16, wherein the complementary reactant comprises flavin or fluorescein isothiocyanate.

26. The article of claim 16, wherein the first click chemical moiety or the second click chemical moiety is an azido group, a nitrile group, a conjugated diene group, an epoxide group, a carbonyl group, or an aziridine group.

27. The article of claim 16, wherein the first click chemical moiety and the second click chemical moiety can react with each other through a 1,3-Huisgen dipolar cycloaddition reaction, a Diels-Alder cycloaddition reaction, a Michael addition reaction, a C═C addition reaction, a nucleophilic ring opening reaction, or a non-Aldol carbonyl reaction.

28. The article of claim 16, wherein the article comprises an array for the analysis of an organic, inorganic or biological analytes.

29. The article of claim 16, wherein the article comprises a sensor, a genome sequencing array, a nucleic acid sensing array, a drug discovery array, a protein sensing array, a peptide array, a non-fouling surface, a low friction surface, an optically active surface, or a lab-on-a-chip sensor.

30. The article of claim 16, wherein the article comprises a surface that comprises a gradient in functional groups.

31. An article comprising:
a patterned material comprising a functionalized patterned surface and a surface that is opposedly disposed to the functionalized patterned surface; the functionalized patterned surface comprising a first click chemical moiety; the first click chemical moiety being reacted with a second click chemical moiety; the second click chemical moiety being part of a complementary reactant.

32. The article of claim 31, wherein the surface that is opposedly disposed to the functionalized patterned surface is patterned.

33. The article of claim 31, wherein the surface that is opposedly disposed to the functionalized patterned surface is reacted with a complementary reactant via click chemistry.
